(19) United States
(12) Patent Application Publication
(10) Pub. No.: US 2007/0113432 A1
(43) Pub. Date: May 24, 2007

(54) Greeting card with removable enclosure for cookie or other items

(76) Inventor: Beth Poole, Springdale, AR (US)

Correspondence Address: HOVEY WILLIAMS LLP, Suite 400, 2405 Grand, Kansas City, MO, 64108, US

(21) Appl. No.: 11/284,359

(22) Filed: Nov. 21, 2005

(51) Int. Cl. G09F 1/00

(52) U.S. Cl. 40/124.06

(57) ABSTRACT

A gift assembly including a greeting card and a removable enclosure for housing a cookie or other item is disclosed. The greeting card includes an aperture and the enclosure includes a base and a cover. The base is operable to at least partially extend through the aperture and the cover is operable to couple with the base to facilitate coupling the enclosure to the greeting card. Such a configuration enables a well-wisher to easily assemble and present the gift assembly without requiring time-consuming assembly. The enclosure also prevents damage to the enclosed item and keeps its fresh longer.

### BACKGROUND OF THE INVENTION

1. Field of the Invention

The present invention relates to greeting cards. More particularly, the invention relates to a gift assembly including a greeting card and a removable enclosure to house a cookie or other items.

2. Description of the Related Art

Greeting cards are a popular method of delivering a birthday wish, congratulation, thoughtful message, or other sentiment. Often, well-wishers give cookies, candy, or other small gifts in combination with greeting cards to further emphasize the delivered message. The cookie or other small gift is usually attached to the greeting card utilizing adhesive, glue, ribbon, etc, to enable the card and the gift to be simultaneously given.

Unfortunately, such gifts must be manually attached to greeting cards after purchase, thereby increasing the amount of time well-wishers must expend to furnish the gifts and decreasing the likelihood of gift giving. Also, well-wishers with diminished artistic skills may be unable to combine a gift and a greeting card in an aesthetically pleasing manner.

Well-wishers also sometimes combine greeting cards with small gifts utilizing a temporary enclosure, such as flexible plastic wrap, plastic bags, etc, to house the gifts. Such temporary enclosures are aesthetically unpleasing, fail to protect fragile gifts, cannot be resealed or reused to house other gifts, and fail to provide a sealed enclosure to preserve gifts, thereby resulting in damaged cards and stale, broken, or otherwise spoiled gifts. Thus, attempts to combine greeting cards and gifts are often unsuccessful.

### SUMMARY OF THE INVENTION

The present invention solves the above-described problems and provides a distinct advance in the art of greeting cards. More particularly, the invention provides a gift assembly including a greeting card and a removable enclosure to house a cookie or other items. Such a configuration enables a well-wisher to easily assemble and present the greeting card and item in combination without requiring time-consuming assembly. The enclosure also prevents damage to the enclosed item and keeps it fresh longer.

In various embodiments, the present invention provides a gift assembly including a greeting card and a removable enclosure for housing a cookie or other item. The greeting card has an aperture and the enclosure may be positioned at least partially in the aperture using a base and a cover to couple the enclosure to the greeting card.

The base may also include a first flange, a raised portion extending from the first flange, and a ridge positioned on the raised portion. The cover may also include a second flange, a groove, and a substantially transparent portion to enable viewing of the item. The enclosure may be coupled to the greeting card by positioning at least a portion of the raised portion through the aperture to enable the groove to receive the ridge to couple the cover and the base together. The flanges generally abut the greeting card when the cover and the base are joined to further facilitate coupling of the greeting card and the enclosure.

The greeting card may also include a front cover to enable the greeting card to present open and closed positions. The front cover has a second aperture to enable the enclosure to extend at least partially through both apertures when the greeting card is closed. Preferably, the enclosure does not extend through the second aperture when the card is open. Such a configuration enables the enclosed item to be viewed regardless of card position and preserves traditional greeting card functionality.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is an exploded-perspective view of various elements of a gift assembly configured in accordance with various embodiments of the present invention, the gift assembly shown including a greeting card and a enclosure for housing a cookie;

FIG. 2 is a perspective view of the gift assembly of FIG. 1, the greeting card shown in a closed position;

FIG. 3 is a perspective view of the gift assembly of FIGS. 1-2, the greeting card shown in an open position with a plurality of candies;

FIG. 4 is a perspective view of the gift assembly of FIGS. 1-3, the enclosure shown having a cover and a base housing the candies;

FIG. 5 is a perspective view of the gift assembly of FIGS. 1-4, the greeting card shown with the cover coupled with the base to enclose the candies;

FIG. 6 is an exploded-perspective view of various elements of a gift assembly configured in accordance with various other embodiments of the present invention, the gift assembly shown including a greeting card and a enclosure presenting a rectangular shape for housing a photograph; and

FIG. 7 is a perspective view of the gift assembly of FIG. 6, the greeting card shown in a closed position and the enclosure shown enclosing the photograph.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

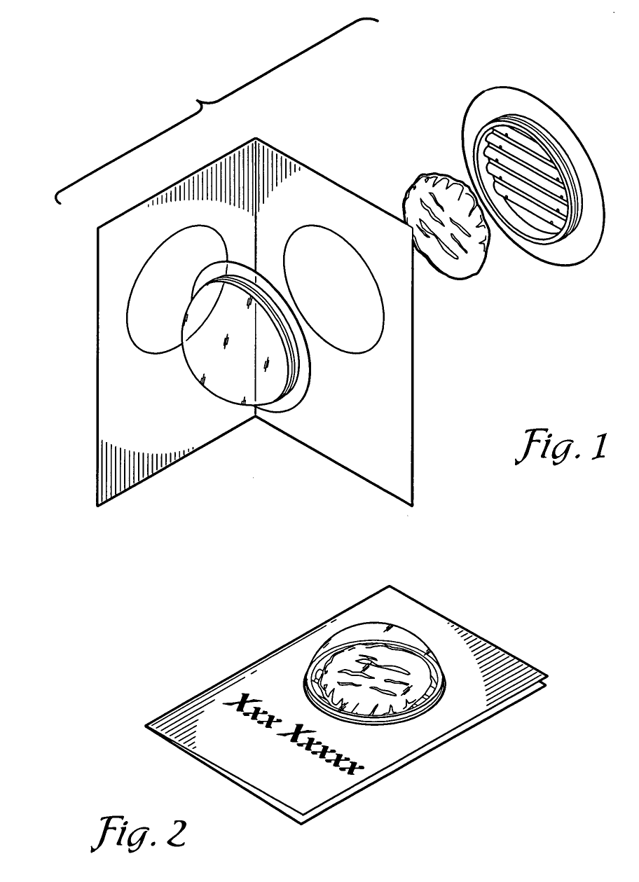

Referring to FIGS. 1-7, a gift assembly 10 is shown constructed in accordance with various preferred embodiments of the present invention. The gift assembly 10 generally includes a greeting card 12 having an aperture 14 and an enclosure 16 having a base 18 and a cover 20 for housing an item. The greeting card 12 and the enclosure 16 are preferably coupled together to comprise an integral gift assembly, however the greeting card 12 and the enclosure 16 may be discrete separate units operable for individual use as described below.

Preferably, the greeting card 12 is comprised of paper or cardboard stock and is formed in a generally rectangular shape in a similar manner to conventional greeting cards. Such a configuration enables the gift assembly 10 and/or greeting card 12 to be housed, displayed, shelved, presented, and sold in a similar manner to conventional greeting cards. However, the greeting card 12 may comprise various materials and shapes, including papers, metals, plastics, etc, to enable the gift assembly 10 and/or greeting card 12 to present innumerable appearances and shapes.

The greeting card 12 includes a main panel 26a having an opposed front 22 and back 24 surfaces. The aperture 14 is formed through the front 22 and back 24 to enable positioning of at least a portion of the enclosure 16 within or through the aperture 14, as described below. Preferably, the aperture 14 has a shape, such as a circular shape, that generally corresponds to the shape of the base 18, or cover 20, to facilitate coupling of the greeting card 12 and the enclosure 16. The aperture 14 is also preferably encircled by the greeting card 12 to further facilitate coupling of the greeting card 12 and the enclosure 16 by enabling a portion of the enclosure 16 to be securely positioned within the aperture 14.

The greeting card 12 may consist of a single sheet of material, such that the greeting card 12 may consist of only the main panel 26a. However, as shown in FIGS. 1-7, the greeting card 12 may additionally include a front cover 26b hingedly coupled to the main panel 26a to enable the greeting card 12 to present open and closed positions. The front cover 26b includes a second aperture 28 that may be substantially similar to the first aperture 14. The front cover 26b may be a discrete element, such as a sheet of paper, that is coupled with the greeting card 12 utilizing hinges or other coupling elements or the front cover 26b may be integral with the greeting card 12 such that the front cover 26b is formed by folding or otherwise modifying the greeting card 12.

In embodiments including the front cover 26b, the apertures 14, 28 are positioned such that they may be aligned to enable at least a portion of the enclosure 16 to pass through both apertures 14, 28 when the greeting card presents the closed position and pass through only the first aperture 14 when the greeting card presents the open position.

When the greeting card 12 is closed, the main panel 26a and the front cover 26b generally overlap such that the apertures 14, 28 align, as shown in FIG. 2. When the greeting card 12 is open, the main panel 26a and front cover 26b do not generally overlap such that the apertures 14, 28 are not aligned and the front 22 of the greeting card 12 is generally viewable, as shown in FIG. 1. In embodiments where the greeting card 12 is comprised of a folded sheet of paper, the open position may correspond to when the sheet is at least partially unfolded and the closed position may correspond to when the sheet is folded over itself.

As will be appreciated, the greeting card 12 may include a plurality of intermediate portions between the main panel 26a and the front cover 26b, each having apertures, to provide innumerable greeting card configurations. The plurality of intermediate portions and associated apertures may be positioned such that the enclosure 16 extends through any combination of the apertures when the greeting card 12 is in open and closed positions.

In various embodiments, at least a portion of the greeting card 12 may present a visual greeting, such as a drawing, picture, text, etc, to facilitate in providing the desired sentiment. The visual greetings may be printed greetings and/or the greeting card 12 may provide an area that enables a user to handwrite or otherwise affix a greeting thereto.

The base 18 and cover 20 may be coupled to enclose the item or items. The base 18 and cover 20 are preferably comprised of a substantially rigid material, such as a 20 mil plastic or equivalents thereof, to prevent deformation and protect the housed item. Utilization of a rigid enclosure 16 enables the gift assembly 10 and enclosed item to survive rough handling during transport, mailing, and storage.

At least a portion of the base 18 is operable to at least partially extend through the aperture 14 to facilitate securing the enclosure 16 to the greeting card 12. Preferably, at least a portion of the base 18 fully extends through the aperture 14 to facilitate coupling of the base 18 and the cover 20. The base also may include a first flange 30 and a raised portion 32 extending generally perpendicularly from the first flange 30 to extend at least partially through the aperture 14.

The first flange 30 preferably presents a substantially flat profile to enable the flange 30 to generally abut the back 24 of the greeting card 12 when the raised portion 32 is at least partially extended through the aperture 14. Further, the shape of the periphery of the flange 30 many correspond to the shape of the aperture to facilitate coupling of the enclosure 16 and the greeting card 12.

The raised portion 32 may comprise and/or form a closed loop to enable at least a portion of the item to be housed, enclosed, or otherwise retained therein. The height of the raised portion 32 is sufficient to enable at least a portion of the raised portion 32 to extend through the aperture 14 for coupling with the cover 20. Thus, the height of the raised portion 32 may be at least equal to the thickness of the greeting card 12 to facilitate coupling of the cover 20 and base 18. However, the height of the raised portion 32 is preferably greater than the thickness of the greeting card 12 to enable at least a portion of the raised portion 32 to extend through the aperture 14 to facilitate coupling with the cover 20.

Additionally, the shape presented by the raised portion 32 is preferably generally similar to the shape provided by the aperture 14 to enable at least a portion of the raised portion 32 to fit snugly within the aperture 14. Such snug fitting of the raised portion 32 within the aperture 14 facilitates secure coupling of the enclosure 16 and the greeting card 12.

The raised portion 32 may additionally include a ridge 34 to facilitate coupling with the cover 20. The ridge 34 may extend along an outer periphery of the raised portion 32 to enable at least a portion of the cover 20 to fit over the raised portion 32 and couple with the ridge 34, as is explained in detail below. The ridge 34 may comprise a continuous raised protrusion extending generally perpendicularly from the raised portion 32, and parallel with the flange 30, and/or the ridge 34 may include intermittent protrusions or protrusions extending in any direction. Preferably, the height of the ridge 34, as measured from the periphery of the raised portion 32, is less than a few millimeters to enable easy coupling and uncoupling of the cover 20 and base 18.

In various embodiments, the base 18 may additionally include an uneven portion 36 substantially parallel and/or coaxial with the first flange 30 and substantially perpendicular to the raised portion 32. The uneven portion 36 includes a plurality of bumps, protrusions, ridges, or other elements to provide an area for coupling with the item to facilitate positioning of the item within the raised portion 32, and generally within the base 18 and enclosure 16, during transport of the gift assembly 10 or other movement of the greeting card 12. Further, the uneven portion 36 provides strength to the enclosure 16, prevents the item from sticking or undesirably adhering to the base 18, and facilitates maintaining the enclosed item in an upright position when the gift assembly 10 is vertically positioned, such as when the gift assembly 10 is positioned on a shelf for display or sale.

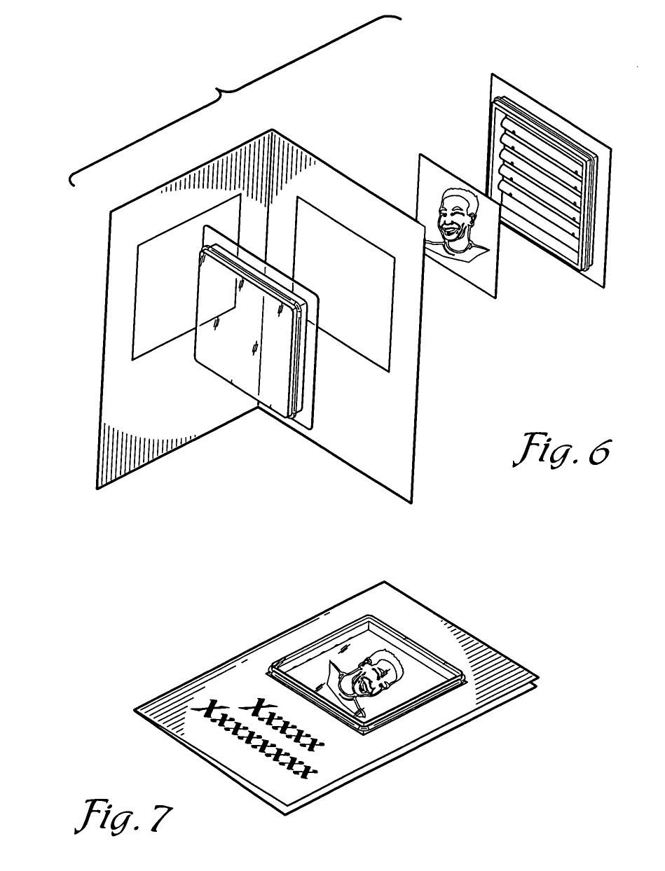

The cover 20 may be coupled with the base 18 to enclose the item. The cover 20 preferably presents a housing portion 38 to provide an area for the item to be enclosed within when the cover 20 and the base 18 are coupled together. The housing portion 38 may present various shapes, sizes, and configurations to conform to the aesthetic elements of the gift assembly 10 and functional elements of the greeting card 12 and base 18. In various embodiments, the housing portion 38 presents a domed shaped to facilitate cookie housing, as shown in FIGS. 1-5 or a rectangular shape to facilitate photo housing, as shown in FIGS. 6-7. Utilization of the domed shaped shown in FIGS. 1-5 enables a ribbon or other decorative element to be easily tied around gift assembly 10 to achieve a desired aesthetic effect.

At least a portion of the cover 20 is sized and configured to mate with the base 18 to couple the cover 20 and base 18 together to form the enclosure 16. Specifically, at least a portion of the housing portion 38 may be sized and configured to mate with the raised portion 32 to couple the cover 20 and base 18 together. Thus, in embodiments where the raised portion 32 presents a generally circular loop, as shown in FIGS. 1-5, at least a portion of the housing portion 38 may also include a generally circular portion having a diameter, circumference, and/or area slightly less or slightly larger than the raised portion 32 to enable at least a portion of the raised portion 32 to snugly fit with or within the housing portion 38.

Additionally, the cover 20, and specifically the housing portion 38, may include a groove 40 operable to receive the ridge 34 to further couple the base 18 and the cover 20. The groove 40 may be positioned on the housing portion 38 to receive the ridge 34 when the raised portion 32 is substantially inserted into, or otherwise coupled with, the housing portion 38.

The mating of the ridge 34 and groove 40 strengthens the coupling of the base 18 and the cover 20 by generally preventing the raised portion 32 from sliding or otherwise inadvertently being removed from the housing portion 38. Further, the coupling of the raised portion 32 and the housing portion 38 substantially seals the enclosure 16, by generally restricting the flow of air in and out of the enclosure 16, to preserve the housed items and prevent spoilage or staleness.

The cover 20 may additionally include a second flange 42 positioned around its periphery and extending substantially perpendicularly to a longitudinal axis of the housing portion 38. Thus, the second flange 42 may be substantially similar to the first flange 30, but coupled with the cover 20 instead of the base 18. As explained below in detail, when the greeting card 12, base 18, and cover 20 are coupled together, the first flange 30 may generally abut the back 24 of the greeting card 12 and the second flange 42 may generally abut the front of the greeting card 12 to facilitate coupling of the greeting card 12 and the enclosure 16. Specifically, the coupling of the flanges 30, 42 to the respective sides of the greeting card 12 prevents the enclosure 16 from moving forward or backward out of the aperture 14 and undesirably detaching from the greeting card 12.

In operation, the gift assembly 10 may be utilized to deliver innumerable messages and items. For instance, the enclosure 16 may house one or more cookies as shown in FIGS. 1-2, a plurality of candies as shown in FIGS. 3-5, a photograph as shown in FIGS. 6-7, paper money and coins, small toys such as dolls, or any items or plurality of items that are operable to fit within the enclosure 16.

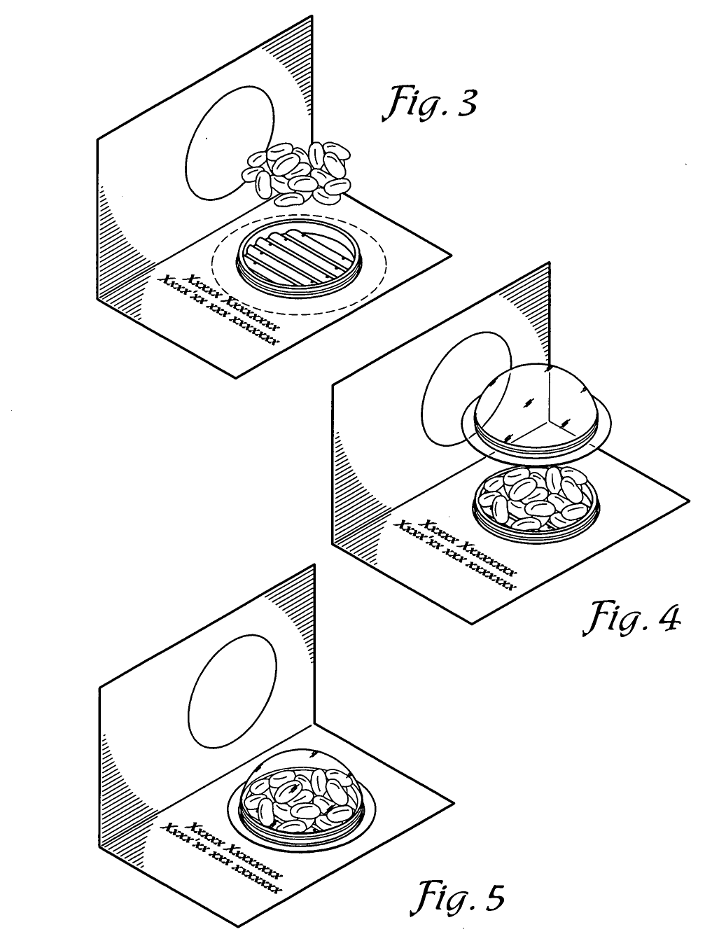

To assemble the gift assembly 10, a user, a merchant, a card manufacturer, etc, couples the base 18 with the greeting card 12 by inserting the raised portion 32 at least partially into the aperture 14 such that the first flange 30 generally abuts the back 24 of the card 12, as shown in FIG. 3. Next, the item or items may be deposited manually or automatically into the base 18, preferably within the raised portion 32, and the cover 20 is positioned for coupling, as shown in FIG. 4. Finally, the cover 20 is coupled with the base 18, by lowering the housing portion 38 onto the raised portion 32 such that the groove 40 receives the ridge 34 and the second flange 42 generally abuts the front 22 of the card 12, as shown in FIG. 5.

As will be appreciated by those skilled in the art, such assembly may be easily implemented utilizing automated machines or other assembly processes due to the ease in which the enclosure 16 may be filled and coupled to the greeting card 12 utilizing the base 18 and the cover 20. For example, the gift assembly 10 is assembled by joining only two elements, the base 18 and the cover 20, around the greeting card 12.

Additionally, such simple assembly of the gift assembly 10 enables users to quickly house items within the enclosure 16 and couple the enclosure 16 to the greeting card 12 in an aesthetically-pleasing manner without expending a significant amount of time. For instance, a candy store may provide users with unassembled assemblies to enable users to fill the enclosure 16 with any selected candy or item, assemble the assembly 10 within the store, and then pay for the combination of the assembly 10 and candy without requiring custom-assembly by the store or card manufacturer and without requiring the use of unattractive or structurally weak elements such as plastic bags.

Further, due to the substantially-sealed enclosure 16 created by the coupling of the base 18 and the cover 20, the shelf-life of the enclosed item may be extended to allow a gift assembly manufacturer to assemble the gift assembly 10 with a perishable item, such as a cookie, and then ship the assembly 10 to a merchant for sale to a user. Additionally, during assembly, air, including oxygen, may be removed from the enclosure 16 before coupling to allow the item to be housed in a generally air-free environment to further prevent spoilage of the item. Similarly, during assembly other gases, such as nitrogen, may be inserted in the enclosure 16 before coupling to further preserve the housed item.

After assembly, the greeting card 12 may be presented in a desired manner with the coupled enclosure 16 without obstructing view or function of the greeting card 12. For example, in various embodiments the user may open and close the greeting card 12 without removing the enclosure 16, due to the position of the apertures 14, 28, to view any presented greetings. Specifically, in embodiments having the front cover 26b, the enclosure 16 extends through both apertures 14, 28 when the greeting card 12 is closed and the enclosure 16 does not extend through the second aperture 28 when the greeting card 12 is open. Such a configuration preserves traditional greeting card functionality while enabling the enclosure 16 and housed item to be viewed regardless of card position.

Further, the coupling of the enclosure 16 and the greeting card 12 enables the gift assembly 10 to maintain a generally conventional greeting card appearance, and not a box or package-like appearance, to increase its aesthetic appeal and shelving and packing ability. Also, in various embodiments the enclosure 16 includes a substantially transparent portion to enable the user to view the enclosed item.

The user may easily remove the item from the enclosure 16 after assembly by uncoupling the base 18 and the cover 20. Specifically, the user may easily pull the base 18 apart from the cover 20 due to the positioning of the base 18 and cover 20 on opposite sides of the greeting card 12. The first flange 30 further facilitates uncoupling as the user may grasp the first flange 30 with his or her fingers to more easily dislodge the raised portion 32 from the housing portion 38, and the associated ridge 34 and groove 40, to free the item from the enclosure 16. Similarly, the second flange 42 may also be independently or simultaneously utilized the uncouple the base 18 and the cover 20.

Additionally, the coupling and uncoupling of the enclosure 16 to the greeting card 12 does not damage or otherwise affect the greeting card 12. Thus, the user may couple and uncouple the enclosure 16 to the greeting card 12 a plurality of times without structurally or aesthetically damaging the greeting card 12. Such functionality enables the user to remove the enclosure 16 from the greeting card 12 and retain the greeting card 12, lacking the enclosure 16, for posteriority, display, or other purposes in an undamaged state. Similarly, such functionality enables a merchant or other entity to easily replace the enclosed item, such as a spoiled cookie, without damaging or replacing the greeting card 12.

Further, the base 18 and the cover 20 may be uncoupled from the greeting card 12 and recoupled together separate from the greeting card 12 to enable the greeting card 12 and enclosure 16 to function and exist as discrete elements. For instance, after receiving the gift assembly 10, the user may remove the enclosure from the greeting card 12 and recouple the base 18 and the cover 20 to store the housed item, such as candy, a cookie, photograph, etc, separately from the greeting card 12. Thus, the enclosure 16, due to its aesthetically pleasing appearance and durable configuration, may function as a candy bowl, cookie holder, package, or photograph frame, separate and independent of the greeting card 12.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A gift assembly comprising:
a greeting card having an aperture; and
an enclosure operable to couple with the greeting card and house an item, the enclosure including a base operable to at least partially extend through the aperture and a cover operable to couple with the base to facilitate coupling the enclosure to the greeting card.

2. The gift assembly of claim 1, wherein the base includes a ridge and the cover includes a groove operable to receive the ridge to couple the base to the cover.

3. The gift assembly of claim 1, wherein the greeting card is operable to present a visual greeting.

4. The gift assembly of claim 1, wherein the cover presents a domed shape.

5. The gift assembly of claim 1, wherein the cover presents a rectangular shape.

6. The gift assembly of claim 1, wherein the base includes a first flange and the cover includes a second flange, and the flanges are operable to generally abut the greeting card.

7. The gift assembly of claim 6, wherein the greeting card includes a front and a back, and the first flange is operable to generally abut the back and the second flange is operable to generally abut the front.

8. The gift assembly of claim 1, wherein the greeting card includes a front cover to enable the greeting card to present open and closed positions, the front cover having a second aperture formed therein to enable the enclosure to extend at least partially through both apertures when the greeting card is in the closed position.

9. The gift assembly of claim 8, wherein the enclosure does not extend through the second aperture when the card is in the open position.

10. The gift assembly of claim 1, wherein the cover includes a substantially transparent portion to enable viewing of the housed item.

11. The gift assembly of claim 1, wherein the enclosure is generally rigid to prevent deformation and damage to the item.

12. The gift assembly of claim 1, wherein the enclosure is operable to be removed from the greeting card after securement thereto and the base and the cover are operable to be recoupled to enable housing of the item independent of the greeting card.

13. A gift assembly comprising:
a greeting card having an aperture and operable to present a visual greeting; and
a generally rigid enclosure operable to couple with the greeting card and house an item, the enclosure including—
a base having a first flange and a raised portion extending from the first flange, the raised portion including a ridge, and
a cover having a second flange, a groove, and a substantially transparent portion to enable viewing of the item, the raised portion of the base being operable to at least partially extend through the aperture to enable the groove to receive the ridge to couple the cover and the base together to facilitate securing the enclosure to the greeting card by enabling the flanges to generally abut the greeting card.

14. The gift assembly of claim 13, wherein the cover presents a domed shape.

15. The gift assembly of claim 13, wherein the greeting card includes a front and a back, and the first flange is operable to abut the back and the second flange is operable to abut the front.

16. The gift assembly of claim 13, wherein the greeting card includes a front cover to enable the greeting card to present open and closed positions, the front cover having a second aperture formed therein to enable the enclosure to extend at least partially through both apertures when the greeting card is in the closed position.

17. The gift assembly of claim 16, wherein the enclosure does not extend through the second aperture when the card is in the open position.

18. A gift assembly comprising:
a greeting card operable to present a visual greeting and having a front, a back, a first aperture, and a front cover to enable the greeting card to present open and closed positions, the front cover having a second aperture formed therein; and
a generally rigid enclosure operable to couple with the greeting card and house an item, the enclosure including—
a base having a first flange and a raised portion extending from the first flange, the raised portion including a ridge, and
a cover presenting a domed shape and having a second flange, a groove, and a substantially transparent portion to enable viewing of the item,
wherein the raised portion of the base is operable to at least partially extend through the first aperture to enable the groove to receive the ridge to couple the cover and the base together to facilitate securing the enclosure to the greeting card by enabling the first flange to generally abut the back of the greeting card and the second flange to generally abut the front of the greeting card,
wherein in the closed position, at least a portion of the enclosure extends through both apertures, and
wherein in the open position, the enclosure does not extend through the second aperture.

19. The gift assembly of claim 18, wherein the coupling of the base and the cover substantially seals the enclosure to facilitate preservation of the item.

20. The gift assembly of claim 18, wherein the enclosure is operable to be removed from the greeting card after securement thereto and the base and the cover are operable to be recoupled to enable housing of the item independent of the greeting card.
